(19) United States
(12) Patent Application Publication
(10) Pub. No.: US 2024/0320463 A1
(43) Pub. Date: Sep. 26, 2024

(54) Detecting and Determining Relevant Variables of an Object by Means of Ultrasonic Sensors

(71) Applicant: Volkswagen Aktiengesellschaft, Wolfsburg (DE)

(72) Inventors: Tobias Kain, Oberndorf/Melk (AT); Jan David Schneider, Wolfsburg (DE); Serin Varghese, Braunschweig (DE)

(73) Assignee: Volkswagen Aktiengesellschaft, Wolfsburg (DE)

(21) Appl. No.: 18/575,929

(22) PCT Filed: Jun. 16, 2022
(86) PCT No.: PCT/EP2022/066488

§ 371 Date: Jan. 2, 2024

(30) Foreign Application Priority Data
Jul. 1, 2021 (DE) 10 2021 206 943.6

(51) Int. Cl. G06N 3/04; B60W 60/00; G06N 3/096

(52) U.S. Cl. CPC G06N 3/04; B60W 60/001; G06N 3/096

(57) ABSTRACT

The disclosure relates to reconfiguring a system architecture of an autonomous vehicle, wherein the system architecture comprises a plurality of application entities and computing nodes, wherein the application entities are executed in a distributed manner across the computing nodes in accordance with a configuration, wherein sensor data detected by a sensor is supplied to at least some of the application entities, and wherein at least some of the application entities generate and provide control signals for controlling the vehicle, wherein at least one item of contextual information of a current context is detected and/or obtained, in which context the vehicle is operated, wherein the at least one item of contextual information is supplied to a trained machine learning method, wherein the trained machine learning method estimates a configuration based on the at least one item of contextual information, and wherein the configuration is adapted in accordance with the estimated configuration.

### CROSS-REFERENCE TO RELATED APPLICATIONS

This application claims priority to German Patent Application No. DE 10 2021 206 943.6, filed on Jul. 1, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor (s), to the extent the work is described in this background section, as well as aspects of the description that may not otherwise qualify as prior art at the time of filing, are neither expressly nor impliedly admitted as prior art against the present disclosure.

The disclosure relates to a method and a device for reconfiguring a system architecture of an autonomous vehicle. The disclosure also relates to a method for training a machine learning method.

A plurality of application entities, which are executed across computing nodes in order to, for example, process detected sensor data and to generate and provide control signals for controlling and/or regulating the vehicle based on the processed sensor data, are required to operate an autonomous vehicle. In this case, the application entities have specific requirements, e.g., with respect to computing power, main memory requirements, storage space, etc. as well as redundancy conditions. The application entities must be distributed across the computing nodes in such a way that these requirements are met. In this case, a respective configuration depends on a context in which the vehicle is located.

### SUMMARY

A need exists to improve a method and a device for reconfiguring a system architecture of an autonomous vehicle.

The need is addressed by methods and devices according to the independent claims. Embodiments are apparent from the dependent claims, the following description, and the drawings.

### BRIEF DESCRIPTION OF THE DRAWINGS

FIG. 1 shows a schematic representation of an embodiment of the device for reconfiguring a system architecture of an autonomous vehicle;

FIG. 2 shows a schematic flowchart of an embodiment of the method for training a machine learning method; and

FIG. 3 shows a schematic representation for illustrating an interaction of an example device in a vehicle with a central server in the field.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In particular, a method for reconfiguring a system architecture of an autonomous vehicle is made available, wherein the system architecture comprises a plurality of application entities and a plurality of computing nodes, wherein the application entities are executed in a distributed manner across the computing nodes in accordance with a configuration, wherein sensor data detected by at least one sensor is supplied to at least some of the application entities, and wherein at least some of the application entities generate and provide control signals for controlling the vehicle, wherein at least one item of contextual information of a current context is detected and/or obtained, in which context the vehicle is operated, wherein the at least one item of contextual information that has been detected and/or obtained is supplied to a trained machine learning method, wherein the trained machine learning method estimates a configuration based on the at least one item of contextual information, and wherein the configuration is adapted in accordance with the estimated configuration.

In particular, a device for reconfiguring a system architecture of an autonomous vehicle is also provided, wherein the system architecture comprises a plurality of application entities and a plurality of computing nodes, wherein the application entities are executed in a distributed manner across the computing nodes in accordance with a configuration, wherein sensor data detected by at least one sensor is supplied to at least some of the application entities, and wherein at least some of the application entities generate and provide control signals for controlling the vehicle, having a context detecting apparatus and a reconfiguration apparatus, wherein the context detecting apparatus is designed to detect and/or to obtain at least one item of contextual information of a current context in which the vehicle is operated, and wherein the reconfiguration apparatus is designed to provide a trained machine learning method, to supply the at least one item of contextual information that has been detected and/or obtained to the trained machine learning method and to have the trained machine learning method estimate a configuration based on the at least one item of contextual information, and to adapt the configuration in accordance with the estimated configuration.

Furthermore, a method for training a machine learning method for application in the method for reconfiguring a system architecture of an autonomous vehicle is in particular provided, wherein training data is generated based on a simulation in which the vehicle and the vehicle surroundings are realistically simulated, wherein contextual information is generated to this end, wherein a configuration is generated in each case for the generated contextual information, and wherein, within the framework of the simulation in which the generated configuration is used, at least one key performance indicator for assessing the generated configuration is determined, wherein the contextual information is used as input data of the machine learning method for training the machine learning method, wherein the associated generated configuration and the associated determined at least one key performance indicator are used as the basic truth during the training, wherein a training data set is generated from such training data, wherein the machine learning method is trained with the generated training data set, and wherein the machine learning method is provided.

Furthermore, a device for training a machine learning method is in particular also provided, having a data processing apparatus with at least one computing apparatus and at least one memory, wherein the data processing apparatus is designed to execute the method for training a machine learning method.

The method and the device for reconfiguring a system architecture of an autonomous vehicle make it possible to provide a configuration for a given context. Since a context in which the vehicle is operated can vary greatly and can comprise a wide range of different characteristics, the result is that it is possible to provide, in particular estimate, a configuration even for contexts which rarely occur or which were previously unknown. A trained machine learning method is used to this end. At least one item of contextual information that is detected and/or obtained is supplied to the trained machine learning method as input data. Based on this, the machine learning method estimates a configuration. A current configuration is adapted in accordance with the estimated configuration.

The method for training a machine learning method for application in the method for reconfiguring a system architecture of an autonomous vehicle also makes it possible to provide a broad base of training data. This is done by generating training data based on a simulation in which the vehicle and the vehicle surroundings are realistically simulated. To this end, contextual information is generated. For example, contexts can be randomly selected within the simulation, wherein the at least one item of contextual information is then derived from the context which is randomly selected in each case. A configuration is, in each case, generated for the generated contextual information. At least one key performance indicator for assessing the generated configuration is determined within the framework of the simulation in which the generated configuration is used. This triple made up of contextual information, configuration and key performance indicator is used for training the machine learning method. To this end, the contextual information is supplied to the machine learning method as input data, wherein the associated generated configuration and the associated determined at least one key performance indicator are used as the basic truth during the training. A training data set is generated from such training data, in particular from such triples. The machine learning method is trained and provided with the generated training data set in a manner known per se. Following the training, the trained machine learning method can estimate a configuration and the at least one key performance indicator based on at least one item of contextual information.

The vehicle and the vehicle environment can be simulated, for example, using at least one of the following simulation tools:
aiSim by aiMotive (https://aimotive.com/aisim),
Pave360 from Siemens AG, (https://www.plm.automation.siemens. com/global/en/our-story/newsroom/pave360-mediaalert/60712),
Carla (Open Source Software, https://carla.org/),
dSPACE (https://www.dspace.com/en/inc/home/products/products.cfm #filterterms=term-488).

In the simplest case, the configuration generated for the at least one item of contextual information can be randomly generated, that is to say that the application entities needed can in particular be randomly distributed across the computing nodes. In this case, merely the requirements predefined by the at least one item of contextual information have to be observed and met. However, it can also be provided that the configuration is generated by means of more complex methods. For example, methods which take into account previously defined constraints can be applied. For example, redundancy requirements, hardware segregation requirements (these define the number of different computing nodes on which a redundant function has to be executed) and/or resource requirements (e.g., memory, CPU and/or network resources) could be defined as constraints. These constraints are then used as the input for a solver which attempts to establish a configuration which meets all of the constraints. In a further exemplary method which can be applied, it is provided that a previously established configuration (e.g., according to the method described above) is easily mutated in each case (e.g., by interchanging application entities assigned to two different computing nodes) before this configuration is used as the input for the simulation.

An application is provided by means of at least one application entity. An application entity is in particular a process which provides a determined functionality and which is executed on at least one computing node. For example, an application entity can provide one of the following functionalities in connection with autonomous driving: environment perception, localization, navigation, trajectory planner or a forecast of ego-behavior and/or the behavior of objects in the environment of the vehicle, etc. To this end, at least some of the application entities obtain sensor data that was detected by means of at least one sensor and/or data from other application entities. At least some of the application entities provide control signals for the vehicle. In particular, the application entities can be operated in one active and in at least one passive operating state. In the active operating state, the application entity has a direct influence on the control of the vehicle. By contrast, in at least one passive operating state, an application entity runs redundantly next to a similar active application entity, receives the same input data and generates the same output data or, respectively control signals, but has no influence on the control of the vehicle. Various levels of the passive state can be provided, which only differ, for example, in how quickly a passive application entity can be transferred to the active operating state. In particular, it is provided that both the active and the passive application entities are monitored. In the event of an error that affects active application entities, the error can be isolated by shutting down the erroneous application entity, and the functionality of the erroneous application entity can be maintained by switching over to a redundant application entity, wherein a new passive application entity is additionally started to restore redundancy conditions. In the event of an error which affects passive application entities, an affected passive application entity can merely be terminated and replaced by a newly started passive application entity with the same functionality, so that redundancy conditions are in particular restored.

In particular, a configuration has an allocation of, in particular active and passive, application entities to individual computing nodes. In particular, the configuration specifies which application entity is executed on which computing node, as well as the associated operating states of the application entities (e.g., active or passive, etc.) in each case. In particular, the configuration depends on predefined redundancy conditions and/or segregation conditions which are or will in each case be predefined depending on the functionalities of the application entities. For example, it can be provided that the redundancy condition prescribes a single redundancy. An active application entity and a passive application entity are then operated for an application or, respectively a functionality. Depending on the application scenario, different redundancy conditions can be provided for the same functionalities, e.g., single redundancy (e.g., pedestrian recognition on a freeway) or multiple redundancy (e.g., quadruple redundancy in the case of pedestrian recognition in a play street).

A segregation condition is in particular a specification for a number of different computing nodes on which an application has to be executed by means of redundant application entities.

A context denotes in particular a description at least of parameters and/or properties which are characteristic of a situation in which the vehicle is located. A context has, for example, information about the environment of the vehicle, a time of day, driver and/or passenger wishes (e.g. comfort wishes, entertainment wishes, etc.) and/or about an error state (erroneous application entities, failed computing nodes, erroneous sensors, etc.).

A context can in particular have at least one item of error information, wherein the at least one item of error information describes errors which occur in application entities and/or computing nodes. For example, application entities which are working erroneously or which have been stopped unexpectedly and/or computing nodes which are erroneous or defective can be described by means of an item of error information. The at least one item of contextual information then also has the at least one item of error information. The configuration can then be adapted, for example, in such a way that the affected application entities are restarted, if necessary, on another computing node, and/or by shutting down an erroneous computing node and by distributing application entities, which were executed on the shutdown computing node, across other computing nodes.

A machine learning method is in particular a neural network. The neural network is in particular a deep neural network which in particular comprises multiple concealed layers. In principle, however, other machine learning methods can be additionally or alternatively deployed. The machine learning method corresponds in particular to a mapping from the input data to a configuration and at least one associated key performance indicator.

The vehicle is in particular a motor vehicle. In principle, however, the vehicle can also be another land, water, air, rail or space vehicle, for example a drone or an air taxi.

It can be provided that the application entities and/or operating systems and/or hardware corresponding to the computing nodes are monitored by means of at least one monitor apparatus, wherein an error in an application entity and/or in an operating system and/or in hardware is recognized by means of the at least one monitor apparatus. The recognized error is in particular isolated by switching over by means of a switching apparatus to application entities which are redundant for the affected application entities in each case. Redundancy conditions and/or segregation conditions predefined for the application entities are restored by reconfiguring the configuration by means of an application placement apparatus. In this case, it is in particular provided that the changed configuration is estimated and provided by means of the method described in this disclosure.

It can be provided that a monitor apparatus is used for each application entity. It can also be provided that a monitor apparatus is used in each case for each operating system and/or each piece of hardware. As a result, monitoring can be executed more reliably and more quickly, so that an error can be recognized more quickly.

Parts of the device, in particular the context detecting apparatus and/or the reconfiguration apparatus and/or the at least one monitor apparatus, can be configured individually or together as a combination of hardware and software, for example as program code which runs on a microcontroller or microprocessor. However, it can also be provided that parts are configured individually or together as an application-specific integrated circuit (ASIC) and/or as a field-programmable gate array (FPGA).

In some embodiments, it is provided that at least one key performance indicator is determined during the application of the adapted configuration and is stored associated with the adapted configuration, wherein training data is generated from the at least one item of contextual information that is detected and/or obtained, the adapted configuration and the determined at least one key performance indicator, and wherein a training data set compiled from such training data is provided as the training data set generated in the field. As a result, an evaluation of the performance in the field can be determined during the application of an estimated configuration and can be utilized for subsequent training of the machine learning method. A key performance indicator (KPI) can in particular include reliability. Reliability describes the probability that the vehicle will not break down within a stipulated period of time (in this case, a reliability value of 100% is thus in particular desirable). A breakdown of an autonomous vehicle could be defined, by way of example, as a complete failure of the autonomous driving function (failure of both a primary system and a backup system). A further key performance indicator is, e.g., a number of accidents which occurred in the simulation or, respectively, virtually caused accidents. Resource utilization of the entire system and/or a range which the vehicle still comprises at the end of the simulation run could be further considered as a key performance indicator.

In some embodiments, it is provided that the training data set generated in the field is transmitted to a central server. As a result, training data obtained in the field from multiple vehicles, in particular from a vehicle fleet, can be collected on the central server and utilized for training the machine learning method.

In some embodiments of the training method, it is provided that the trained machine learning method to be provided is downloaded into a memory of a reconfiguration apparatus of at least one vehicle. As a result, the trained machine learning method can be placed directly in the field for the application.

In some embodiments of the training method, it is provided that at least one training data set generated in the field is obtained and is added to the training data set. As a result, the machine learning method can be (re) trained, taking into account training data generated or, respectively, collected in the field under real application conditions.

In some embodiments of the training method, it is provided that the training data set is only generated from such training data and/or only such training data is added to the training data set, which training data has at least one key performance indicator that meets at least one predefined selection criterion. As a result, a training data set that has already been optimized in terms of the predefined selection criterion can be generated and provided. In the field, this allows the machine learning method trained by means of the already preselected training data set to estimate configurations that have already been optimized in terms of the at least one predetermined selection criterion, based on the contextual information that is detected and/or obtained. Not only is any possible configuration available herewith, but rather an improved configuration which has at least one key performance indicator that already meets the at least one selection criterion.

The at least one selection criterion can contain, for example, at least one predefined threshold value and/or a range of values for at least one key performance indicator.

In some embodiments of the training method, it is provided that the simulation and training are performed on a central server. As a result, significantly larger calculation resources (computing power and memory) can be provided than would be possible in a vehicle, for example. In addition, the training on a central server makes it possible to take into account training data that is obtained in the field from vehicles of a vehicle fleet.

In particular, a vehicle is also created, having at least one device according to one of the described embodiments.

The invention is explained in greater detail below on the basis of various exemplary embodiments, with reference to the FIGS.

Specific references to components, process steps, and other elements are not intended to be limiting. Further, it is understood that like parts bear the same or similar reference numerals when referring to alternate FIGS.

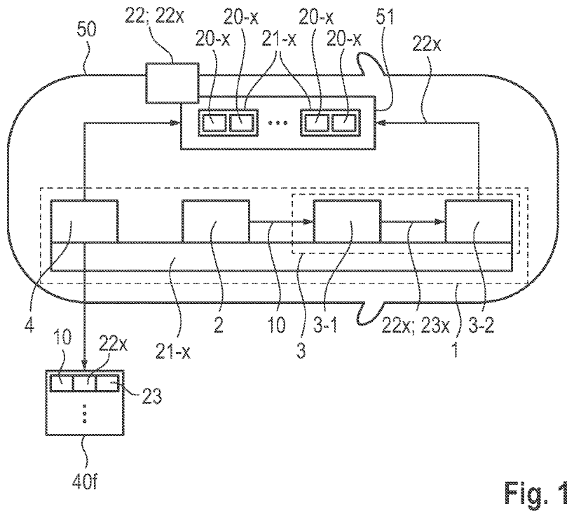

FIG. 1 shows a schematic representation of an embodiment of the device 1 for reconfiguring a system architecture 51 of an autonomous vehicle 50. The device 1 executes the method for reconfiguring the system architecture 51 of the autonomous vehicle 50, which is described in this disclosure.

The system architecture 51 has a plurality of application entities 20-x and a plurality of computing nodes 21-x, wherein the application entities 20-x are executed in a distributed manner across the computing nodes 21-x in accordance with a configuration 22. Sensor data detected by at least one sensor is supplied to at least some of the application entities 20-x, and at least some of the application entities 20-x generate and provide control signals for controlling the vehicle 50.

The device 1 has a context detecting apparatus 2 and a reconfiguration apparatus 3. The context detecting apparatus 2 and the reconfiguration apparatus 3 can, for example, be executed as a combination of hardware and software on a computing node 21-x.

The context detecting apparatus 2 is designed to detect and/or to obtain at least one item of contextual information 10 of a current context in which the vehicle 50 is operated. A context has, for example, information about an environment of the vehicle 50, a time of day, driver and/or passenger wishes (e.g., comfort wishes, entertainment wishes, etc.) and/or about an error status (erroneous application entities, failed computing nodes, erroneous sensors, etc.). The at least one item of contextual information 10 is derived or determined by the context detecting apparatus 2, for example, from detected sensor data, and/or is received from a service provider (e.g., weather data, etc.).

The reconfiguration apparatus 3 provides a trained machine learning method 3-1, in particular in the form of a trained neural network. The trained machine learning method 3-1, in particular the trained neural network, is trained to estimate a configuration 22x based on the at least one item of contextual information 10. The reconfiguration apparatus 2 also has a configuration adapting apparatus 3-2. The configuration adapting apparatus 3-2 is designed to adapt the configuration 22 in accordance with the estimated configuration 22x. To this end, the configuration adapting apparatus 3-2 configures the application entities 20-x across the computing nodes 21-x in accordance with the estimated configuration 22x.

A benefit of the device 1 is that a configuration 22x can be estimated even for rare or unknown contexts so that, regardless of a specific characteristic of the context in which the vehicle 50 is currently located, a configuration 22 can always be made available.

It can also be provided that the trained machine learning method 3-1, in particular the trained neural network, also estimates at least one key performance indicator 23x associated with the estimated configuration 22x.

The sequence described is in particular continuously repeated so that a context-dependent configuration 22x is continuously and repeatedly estimated. In this case, it can be provided that the context detecting apparatus 2 continuously detects and/or obtains the current context and only transmits the at least one (changed) item of contextual information to the reconfiguration apparatus 3 in the event of a change in context.

It can be provided that at least one key performance indicator 23 is determined during the application of the adapted configuration 22x and is stored associated with the adapted configuration 22x, wherein training data is generated from the at least one item of contextual information 10 that is detected and/or obtained, the adapted configuration 22x and the determined at least one key performance indicator 23, and wherein a training data set compiled from such training data is provided as the training data set generated in the field 40f. The at least one key performance indicator 23 is determined, for example, by means of a monitor apparatus 4.

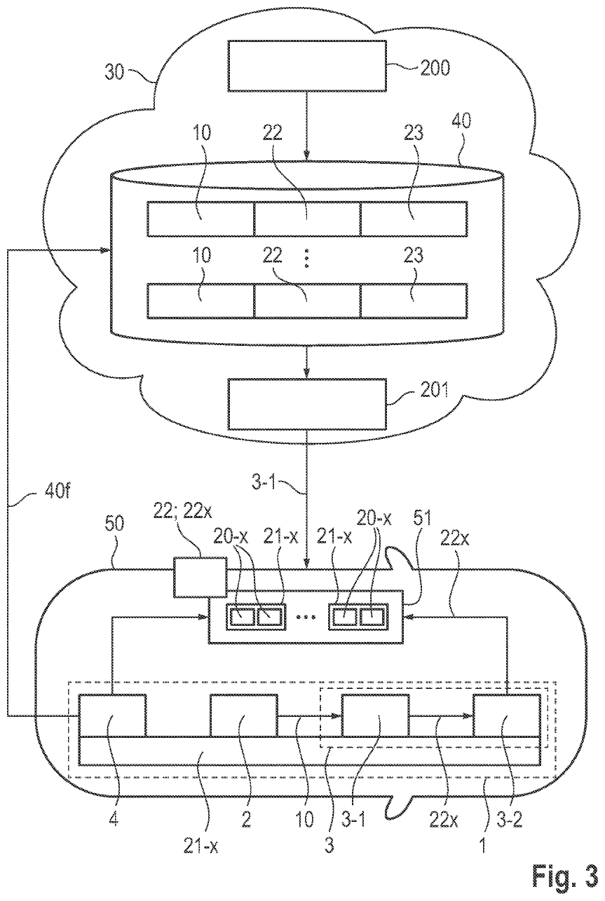

In a further development, it can be provided that the training data set generated in the field 40f is transmitted to a central server 30 (FIG. 3).

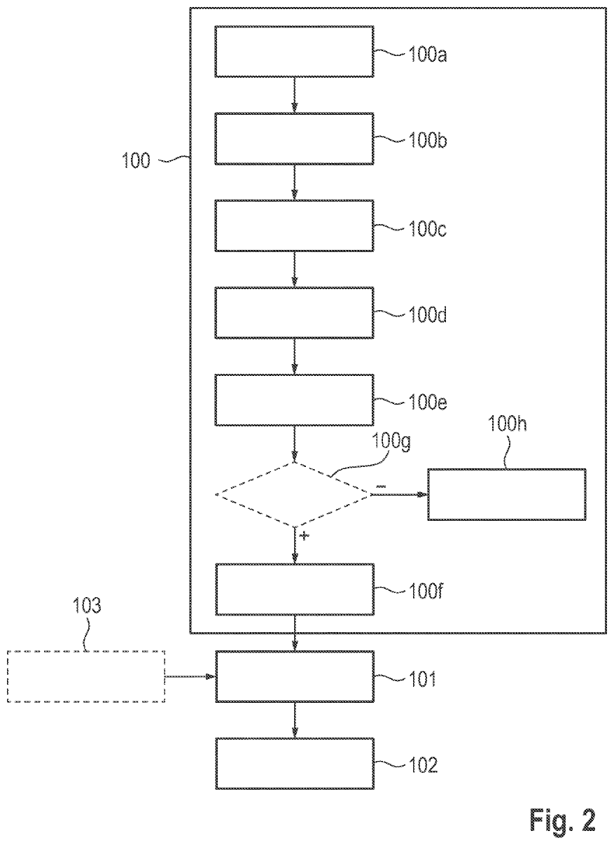

FIG. 2 shows a schematic flowchart of an embodiment of the method for training a machine learning method for application in the device or, respectively in the associated method.

In a measure 100, training data is generated based on a simulation in which the vehicle and the vehicle surroundings are realistically simulated.

To this end, contextual information (vehicle surroundings, driver wishes, error states of application entities and/or of computing nodes and/or of sensor technology, etc.) is generated in a measure 100a. In a measure 100b, a configuration is also generated for the generated contextual information. In the simplest case, the configuration is randomly generated. However, the generated configuration must meet the predefined requirements. In a measure 100c, the simulated vehicle is configured in accordance with the generated configuration, that is to say the application entities are distributed across (simulated) computing nodes in accordance with the generated configuration. In a measure 100d, the vehicle is simulated in the vehicle surroundings in the associated context. In a measure 100e, at least one key performance indicator for assessing the generated configuration is determined during the simulation. In a measure 100f, training data is created from the contextual information, the generated configuration and the determined at least one key performance indicator and supplied to a training data set.

The measures 100a to 100f are repeated for a predefined quantity of training data.

In a measure 101, the machine learning method, in particular a neural network, is trained by means of the training data set. The contextual information is used as the input data of the machine learning method for training the machine learning method. The respectively associated generated configurations and the associated determined at least one key performance indicator are used as the basic truth during the training. The machine learning method is otherwise trained in a manner known per se.

Following the training, the trained machine learning method is provided, in particular in the form of a data packet, which describes and/or includes a structure and parameters of the trained machine learning method, in a measure 102.

It can be provided that the trained machine learning method, in particular the trained neural network, to be provided is downloaded into a memory of a reconfiguration apparatus of at least one vehicle, in measure 102. In particular, it can be provided that the trained machine learning method, in particular the trained neural network, is transmitted to vehicles of a vehicle fleet and is downloaded into the respective memories of the reconfiguration apparatuses of the individual vehicles.

It can be provided that at least one training data set generated in the field is obtained and is added to the training data set in a measure 103.

It can be provided that the training data set is only generated from such training data and/or only such training data is added to the training data set, which training data has at least one key performance indicator that meets at least one predefined selection criterion. To this end, it is checked whether the at least one key performance indicator meets the at least one selection criterion or not in a measure 100g. If the at least one key performance indicator meets the at least one selection criterion, the triple made up of contextual information, configuration and at least one key performance indicator is added to the training data set as training data in measure 100f, otherwise the triple is discarded in measure 100h and no longer taken into account.

It can be provided that the simulation and training are performed on a central server.

FIG. 3 shows a schematic representation for illustrating an interaction of a device 1 in a vehicle 50 in the field with a central server 30. In principle, the device 1 and the vehicle 50 are configured as in the embodiment which is shown in FIG. 1. The same reference numerals describe the same features and terms.

The method for training the machine learning method is executed on the central server 30, for example in one embodiment, as was described with respect to FIG. 2. To this end, training data is generated by means of a simulation of the vehicle and of the vehicle surroundings in a measure 200, as already described in the preceding text. The training data has triples made up of at least one item of contextual information 10, a configuration 22 and at least one key performance indicator 23 and forms a training data set 40. In a measure 201, a machine learning method, in particular a neural network, is trained by means of the training data set 40.

Following the training, the trained machine learning method 3-1, in particular the trained neural network, is transmitted by the central server 30 to at least one vehicle 50, for example via a wireless communication interface (not shown). In particular, this is done in the form of a structural description and parameters of the trained machine learning method, in particular of the trained neural network.

The at least one vehicle 50 receives the trained machine learning method 3-1, in particular the trained neural network, and downloads this into a memory of the reconfiguration apparatus 3. The trained machine learning method 3-1 is subsequently applied, as already described with respect to the embodiment in FIG. 1.

A training data set 40f generated in the field by means of the monitor apparatus 4 is transmitted to the central server 30 and inserted into the training data set 40 by the central server 30. This can be done in particular for training data sets generated in the field 40f from vehicles 50 of a vehicle fleet. As a result, the training data set 40 can be continuously expanded and updated.

### LIST OF REFERENCE NUMERALS

1 Device
2 Context detecting apparatus
3 Reconfiguration apparatus
3-1 Trained machine learning method
3-2 Configuration adapting apparatus
4 Monitor apparatus
10 Contextual information
20-x Application entities
21-x Computing nodes
22 Configuration
22x Estimated configuration
23 Key performance indicator
23x Estimated key performance indicator
30 Central server
40 Training data set
40f Training data set generated in the field
50 Vehicle
51 System architecture
100-102 Measures of the method (training)
200, 201 Measures

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for reconfiguring a system architecture of an autonomous vehicle, wherein the system architecture comprises a plurality of application entities and a plurality of computing nodes, wherein the application entities are executed in a distributed manner across the computing nodes in accordance with a configuration, wherein sensor data detected by at least one sensor is supplied to at least some of the application entities, and wherein at least some of the application entities generate and provide control signals for controlling the vehicle, the method comprising:
obtaining at least one item of contextual information of a current context, in which context the vehicle is operated;
supplying the at least one item of contextual information to a trained machine learning method;
estimating, by the trained machine learning method, a configuration based on the at least one item of contextual information; and
adapting the configuration in accordance with the estimated configuration.

12. The method of claim 11, wherein at least one key performance indicator is determined during the application of the adapted configuration and is stored associated with the adapted configuration, wherein training data is generated from the at least one item of contextual information that is detected and/or obtained, the adapted configuration and the determined at least one key performance indicator, and wherein a training data set compiled from such training data is provided as the training data set generated in the field.

13. The method of claim 12, wherein the training data set generated in the field is transmitted to a central server.

14. A method for training a machine learning method for application in the method of claim 11, comprising:
generating training data based on a simulation in which the vehicle and the vehicle surroundings are realistically simulated;
generating contextual information to this end, wherein a configuration is generated in each case for the generated contextual information;
determining, within the framework of the simulation in which the generated configuration is used, at least one key performance indicator for assessing the generated configuration; wherein
the contextual information is used as input data of the machine learning method for training the machine learning method; wherein
the associated generated configuration and the associated determined at least one key performance indicator are used as the basic truth during the training; wherein
a training data set is generated from such training data; and wherein
the machine learning method is trained with the generated training data set.

15. The method of claim 14, wherein the trained machine learning method is downloaded into a memory of a reconfiguration apparatus of at least one vehicle.

16. The method of claim 14, wherein at least one training data set generated in the field is obtained and is added to the training data set.

17. The method of claim 14, wherein the training data set is only generated from such training data and/or only such training data is added to the training data set, which training data has at least one key performance indicator that meets at least one predefined selection criterion.

18. The method of claim 14, wherein the simulation and training are performed on a central server.

19. A device for reconfiguring a system architecture of an autonomous vehicle, wherein the system architecture comprises a plurality of application entities and a plurality of computing nodes, wherein the application entities are executed in a distributed manner across the computing nodes in accordance with a configuration, wherein sensor data detected by at least one sensor is supplied to at least some of the application entities, and wherein at least some of the application entities generate and provide control signals for controlling the vehicle, the device having:
a context detecting apparatus; and
a reconfiguration apparatus; wherein
the context detecting apparatus is configured to detect and/or to obtain at least one item of contextual information of a current context in which the vehicle is operated; and
wherein the reconfiguration apparatus is configured to provide a trained machine learning method, to supply the at least one item of contextual information that is detected and/or obtained to the trained machine learning method and to have the trained machine learning method estimate a configuration based on the at least one item of contextual information, and to adapt the configuration in accordance with the estimated configuration.

20. A vehicle, having at least one device of claim 19.

21. The method of claim 15, wherein at least one training data set generated in the field is obtained and is added to the training data set.

22. The method of claim 15, wherein the training data set is only generated from such training data and/or only such training data is added to the training data set, which training data has at least one key performance indicator that meets at least one predefined selection criterion.

23. The method of claim 16, wherein the training data set is only generated from such training data and/or only such training data is added to the training data set, which training data has at least one key performance indicator that meets at least one predefined selection criterion.

24. The method of claim 15, wherein the simulation and training are performed on a central server.

25. The method of claim 16, wherein the simulation and training are performed on a central server.

26. The method of claim 17, wherein the simulation and training are performed on a central server.
